(19) United States
(12) Patent Application Publication
(10) Pub. No.: US 2011/0253590 A1
(43) Pub. Date: Oct. 20, 2011

(54) LOADABLE CONTAINER ABLE TO BE COLLAPSED IN CASE OF NO LOAD

(75) Inventors: Jussi Lemola, Espoo (FI); Tom Mellin, Porvoo (FI)

(73) Assignee: DEUTSCHE POST AG

(21) Appl. No.: 13/141,620

(22) PCT Filed: Dec. 16, 2009
(86) PCT No.: PCT/EP09/09019

§ 371 Date: Jun. 22, 2011

(30) Foreign Application Priority Data
Dec. 29, 2008 (EP) 08022489.2

(51) Int. Cl. B65D 19/06; B23P 19/04

(52) U.S. Cl. 206/600; 29/426.1

(57) ABSTRACT

There is provided a container loadable with at least one object. The container comprises a pallet with a loadable upper side and first protruding fastening means arranged apart from the edges of the pallet. The container also comprises a closable sidewall with second fastening means suitable to fit into the first fastening means of the pallet comprising at least a first side, a second side, a third side and a fourth side. The fourth side is configured to be opened to load the container. The sidewall and the pallet may be fastened together with the first and second fastening means defining a loadable volume which is able to be collapsed in case of no loaded objects by moving the sidewall towards the upper side of the pallet, for of at least two of the first to fourth sides along the first fastening means. The sidewall may be detachable from the pallet. The sides of the sidewalls may be detachable from each other to enable a separate replacement of the sides without replacing the complete sidewall.

### CROSS-REFERENCE TO RELATED APPLICATIONS

Pursuant to 35 U.S.C. §371, this application is the United States National Stage Application of International Patent Application No. PCT/EP2009/009019, filed on Dec. 16, 2009, the contents of which are incorporated by reference as if set forth in their entirety herein, which claims priority to European (EP) Patent Application No. 08 022 489.2, filed Dec. 29, 2008, the contents of which are incorporated by reference as if set forth in their entirety herein.

### BACKGROUND

Objects to be transported were traditionally arranged on loose load pallets, without any sidewalls having typical sizes of 80×120 cm² (depth/length). Such loaded pallets have to be moved slowly to avoid objects from falling off the pallet. Furthermore there is no protection against side impacts and loaded pallets are not stackable without risks of slipping pallets and/or damaged objects due to the weight pressure of above stacked pallets. Wrapping the objects were in order to lower the risk of losing object during transport would require additional time consuming effort. To avoid the above mentioned disadvantages, closed metal cages were fixed to a pallet. Such pallets with metal cages define typically a container volume of 80×120×190 cm³ (depth/length/height). However, such containers were not stackable, difficult to repair in case of damage and not able to collapse when unloaded resulting in a significant required amount of storage space even in an unloaded status.

Document DE 102006022196 discloses a foldable and stackable box comprising a bottom and a top plate sandwiching a closed one-piece sidewall defining a container volume. One disadvantage of this container is the difficult loading and de-loading. The absence of any opening within the sidewall, it is not possible to load the container by lateral movements of objects into the box. Each object has to be carefully lifted across the lower closed sidewall and afterwards carefully deposited down to the bottom of the box. This loading procedure is time consuming and eventually threatening the health of workers in case of loading the box by hand. The disclosed box is only moveable with a fork lift, if two additional pallets are arranged below the bottom plate and above the top plate. The disadvantage of this arrangement is the use of additional components: a double bottom (bottom plate and bottom pallet) for fork lift transports and a double top (top plate and top pallet) to stabilize the box during transport. A further disadvantage is the use of closed one-piece sidewalls, which have to be replaced in total even if a damage is present only at one side of the sidewall.

### SUMMARY

The subject innovation relates to a loadable container able to be collapsed in case of no load comprising a closable sidewall. The subject innovation further relates to corresponding sidewalls and pallets and to a method to collapse the container in case of no load.

The subject innovation may provide a loadable container able to be easily collapsed in case of no load, where the number of required components to build the container is reduced while simultaneously improving the ease of loading and de-loading.

Additionally, the subject innovation may relate to a container loadable with at least one object comprising a pallet with a loadable upper side and first fastening means arranged apart from the edges of the pallet and a closable sidewall with second fastening means suitable to fit into the first fastening means of the pallet comprising at least a first side, a second side, a third side and a fourth side, where the fourth side is suitable to be opened to load the container, wherein the sidewall and the pallet fastened together with the first and second fastening means define a loadable volume which is able to be collapsed in case of no loaded objects by moving the sidewall towards the upper side of the pallet, for at least two of the first to fourth sides along the first fastening means. This container is easily loadable, because the opened fourth side enables the loading stuff to place objects directly into the container without lifting and afterwards carefully putting down the objects. In case of large containers, the containers may be loaded directly from a forklift or other loading machines and/or loading techniques. The risk of health hazards to the loading stuff carrying too heavy objects is therefore reduced. Furthermore, the possibility to collapse the sidewall saves space in transport vehicles during the transport of empty containers. Collapsed (or shrunken) containers can be stacked on top of each other. Assuming typical sizes of pallets, and sidewalls, a stack of several collapsed containers only consume the space of one non-collapsed container. This reduces the overall transportation costs of container according to the subject innovation. The closed sidewall of loaded containers provides protection of the loaded objects against side impacts and other events capable to damage the objects, especially when the sidewall and/or the pallet is made of impact resilient materials. The first and second fastening means further improve said protection and provide a secure locking structure of the container against events from the outside. Also the stacked objects inside the container are secured against slipping. The presence of a pallet as part of the container enables the use of forklifts during loading processes and pallet trucks during transportation. The possibility to detach the sidewall from the pallet, especially the parts of the sidewall, the first side, the second side, the third side and the fourth side from each other, enables a separate and effortlessly replacement of such elements in case of damage without replacing the complete sidewall. The sidewall has an open base to minimize the required parts to build a closed sidewall. Additionally, a base is not required because the pallet form the base of the container. The required time for replacements is below 1 minute. Also damaged pallets can be replaced without replacing the whole container. The use of the term loading should be understood to relate also to the inverted process of de-loading. Arguments valid for loading are almost valid for de-loading. The term “pallet” denotes all kind of pallets, especially pallets suitable to be moved and/or transported with forklifts. This could be standard pallets, any loadable container base plates and/or base plates/pallets with mounted wheels suitable to be transported with a forklift.

The arrangement of the fastening means apart from the edges of the pallet avoids damage of said fastening means during transport or stacking of containers, because the highest risk of collisions with other containers, edges, walls etc is present at the edges of a pallet.

In one exemplary embodiment of the container, the first side, the second side and the third side, preferably also the fourth side, are connected to each other via connection means comprising clips, flaps, pins, bolts anchors, clamps, clips, mounting links and hooks to provide a closed sidewall. Depending on the process how to open the container the fourth side is connected to the first side and the third side via the connection means. Here, the fourth side is not considered as a door, but as a replaceable element to open the container. To load the container, the fourth side is detached front the remaining sides of the sidewall (first side, second side, third side). After loading, the fourth side is connected again to the first and third side in order to provide a closed sidewall for the following transportation.

In another exemplary embodiment, the fourth side is provided as a door, preferably a double wing door, connected to the vertical edge of the first side and/or third side facing towards the fourth side via at least one opening mean suitable to provide an opening angle of the door (or double wing door) of 90°, preferably 180°, more preferred 270°. When the container should be loaded the door will be opened along the vertical edge of one side, first side or third side, in case of a single wing door. In case of a double wing door, both wings will be opened along the vertical edges of the first and third side to provide easy access to the whole loadable volume of the container. The opening angle provided by the opening means allows different handling procedures. At least 90° are required to enable direct loading of the whole loadable volume of the container. Several container placed beside each other can be loaded simultaneously. 180° enables to load objects into the container also from loading directions not parallel to the first and third sides of the sidewall. The loading can be executed more variable, but containers cannot be placed side by side for simultaneous loading. An opening angle of 270° prevents damaging of the door (or both door wings in case of a double wing door) during loading. Here, several containers placed beside each other with previously opened doors can be loaded simultaneously but the doors cannot be closed directly after loading. Hinge, flexible joint, angle, clip, or flap or combinations thereof are suitable examples of opening means. People skilled in the art may also consider other opening means.

In another exemplary embodiment, the door further comprises closing means to fasten the door, such as door lockers, bars or other closing means known by people skilled in the art. Closing means provide a secure locking structure to protect the loaded objects to achieve a closed sidewall.

The pallet may have any size, e.g. a standard size of 80×120 cm². However, in another exemplary embodiment, the pallet and the sidewall define a customized loadable volume of the container, preferably a volume of 120×120×120 cm³, where the pallet size is 120×120 cm². A customized loadable volume adapted to the available storage space, e.g. in trucks, ships, trains or air planes will save transportation costs due to the more effective use of available storage space. In a preferred embodiment, the volume of 120×120×120 cm³ is optimized to the available standard trailer volume (Nordic pool size) of approximately 240×260×1200 cm³. If the thickness of the sidewall is large enough, another container is stackable on top of a first container. In an exemplary embodiment the container comprises further means in order to be stackable, preferably additional supporting posts preferably located in the corners of the pallet or a cover for the sidewall to improve the stiffness of the sidewall (further strengthen the sidewall). The supporting posts may be made of any material, e.g. metal, fiberglass or hard plastic, which is sufficiently resilient to be stackable with another loaded container. The possibility to stack containers according to the subject innovation will lead to a further more effective use of available storage space. In said standard trailer 40 containers according to the preferred embodiment can be stored if stacked as units of two containers each and loaded in two lines into the trailer increasing the trailer load of at least 25% compared to state of the art containers with common sizes of 120×80 cm² and heights of approximately 190 cm. Compared to stacked loose load pallets the use of our stackable container with volume of 120×120×120 cm³ will improve the trailer load by 33%.

In another exemplary embodiment, the sidewall of the container is essentially made of at least one a material selected from the group of materials comprising cardboard, treated cardboard and plastic, preferably water resistant and/or recyclable. The use of the above listed materials provide an environmental sustainable solution and will decrease the production costs of sidewalls compared to expensive materials such as metal sidewalls or the like. Wrecked material can be recycled and turned back to functional sidewalls or part of the sidewall (first side, third side etc.). These materials still provide a secure locking structure. It is known to skilled people, that the listed materials are water resistant (plastic) or can be made water-resistant in case of cardboard or treated cardboard. Furthermore, these materials are RFID (radio frequency identification) compatible in contrast to metal containers or other containers acting as a Faraday cage, where the RFID signal of objects equipped with RFID tags inside the container cannot be detected. Containers made of the claimed materials are furthermore easy to recognize and global implementable. Such containers still have a light weight and still a load capacity of 300-400 kg. Furthermore, the material is corrosion free, which avoids expensive maintenance procedures.

To further improve (lower) the weight of the container at least one of the first side, second side, third side and fourth side comprises at least one opening in order to reduce the weight of the sidewall. The opening may have any shape. Instead of one opening there may be a regular of irregular pattern of openings of the same or different shapes. In one exemplary embodiment, the sidewall has a regular pattern of hexagonally shaped openings covering between 30%-50% of the sidewall area. The reduced weight corresponds to the weight of the sidewall area equal to the total area of openings.

In another exemplary embodiment, the first and second fastening means comprise at least one element of the group of elements comprising hinges, clips, flaps, pins, bolts, clamps, clips, mounting links, angle, hooks, local ledges or local edges, or combinations thereof. There may be one or more second fastening means on each first side, second side and/or third side. If the fourth side is not provided as a door, there may be also second fastening means at the fourth side. According to the second fastening means, there are corresponding first fastening means at the pallet. In a preferred embodiment, neither the fourth side of the sidewall nor the corresponding side of the pallet comprises second or first fastening means in order allow an easy loading without any fastening means eventually blocking or damaging objects loaded through the fourth side. In case of a door as the fourth side, the door is connected to the first side and/or third side and therefore is fastened to the pallet via the fastening means of the first side and/or third side.

In another exemplary embodiment, the second side of the sidewall comprises a foldable line arranged parallel to the edge of the second side facing towards the pallet in distance of at least the cumulative thickness of first side, third side and fourth side for folding the backside on top of the collapsed first side, third side and fourth side. In this arrangement, the container can be collapsed without detaching the second side from the pallet. This will decrease the time required for collapsing the container and simultaneously improving the stability of the collapsed container during transport. The risk of damaging collapsed container during stacking is reduced, when each collapsed container has an improved stability.

In another exemplary embodiment, the container further comprises at least two telescope elements arranged in least two of the corners of the sidewall and each telescope element comprises a telescoping part and a guiding part to guide the telescoping part, with at least one telescope sidewall mounted to the telescoping parts of the at least two telescope elements in order to vary the height of the container. Here, the loadable volume can be easily varied depending on the amount of loaded objects. Furthermore, the telescope elements improve the stiffness (resilience) of the sidewall against side impacts. The presence of a telescope sidewall behind the sidewall further improves this property. The telescoping part is commonly inside the guiding part to enable the guiding part to guide the telescoping part. Skilled people may choose other arrangements between telescoping and guiding parts within the scope of the subject innovation. The telescope sidewall may be made from the same material as the sidewall. In alternative exemplary embodiments, the telescope sidewall and/or at least one of the sides of the sidewall may be arranged as a net or as a frame with mounted net. The telescope elements in a non-telescoped status (minimum length of the telescope element) may have any length within the scope of the subject innovation, for example smaller or larger than the height of the sidewall. The preferred length of the non-telescoped status is essentially identical to the height of the sidewall. Here, containers are stackable directly on top of the telescope elements without any further handling. In case of telescope elements smaller than the height of the sidewall, the telescope part has to be move upwards to adapt the height of the telescope element identical to the height of the sidewall in order to provide a stackable container. If the non-telescoped status has a length larger than the height of the sidewall, a further container is stackable on top of the telescope elements with a gap between sidewall and pallet of the container stacked on top. The telescope elements on top of the pallet should be sufficiently resilient in order to enable the container to be stackable, even in a loaded status. In order to support stacking of the container, the telescope elements have to be placed either directly on top of the pallet or indirectly via suitable means between telescope elements and pallet. In order to be sufficiently resilient, the telescope element may be made of a resilient material such as fiberglass, metal, or hard plastics. Skilled people may choose other suitable materials within the scope of the subject innovation. The resilience of the telescope element may further be improved by a suitable cross section of the telescope element and/or thickness and/or diameter of the telescope element. The highest resilience is achieved by a telescope element made of a suitable material with optimized cross section (preferred rectangular, more preferred triangular, even more preferred pentagonal or hexagonal cross sections) and an adapted wall thickness and/or diameter of the telescope element. Preferably the telescope elements further comprises at least one fixation mean in order to fix the telescope part to the guiding part in a selected position.

In another exemplary embodiment, the container further comprises at least one shelf suitable to be loaded with objects and at least one side of the sidewall is suitable to be opened in order to load the upper side of the pallet and the shelf randomly. The present shelf can be loaded through the opened side enabling a fast access of the loadable volume of the pallet and the shelf simultaneously. Furthermore, small and/or light and/or fragile objects can be placed onto the shelf, while placing the large and/or heavy and/or non-fragile objects onto the loadable upper side of the pallet. Subsequently, the risk of damaging the objects on top of the shelves by slippage of the objects loaded on top of the pallet is at least reduced. Furthermore, heavy objects are loaded on top of the pallet and therefore cannot damage the objects on top of the shelves due to their weight. The simultaneous access to the loadable volume on top of the shelves as well as to the remaining volume on top of the pallet avoids any required sorting of objects before loading. Each object can be loaded independently from its weight or fragility directly to the container, either on top of the shelves or on top of the pallet. By maintaining a secure transport of objects with different properties (volume, weight, fragility), the required loading time is not extended in contrast to containers without shelves. A random and fast loading process can still be applied to a container according to the subject innovation. The shelves may be made from the same materials as the sidewall. In alternative exemplary embodiments, the shelf may be a net, a frame with a net fastened to the frame or made of cotton. People skilled in the art may choose alternative materials for the shelves within the scope of the subject innovation. The shelves may be placed on top of the pallet or may be mounted to at least one of the sides of the sidewall by suitable mounting means.

The subject innovation further relates to a method of collapsing a container in case of no load, comprising the steps
open the connection means of the sidewall,
moving the first side, the third side and the fourth side towards the upper side of the pallet, wherein the movement is in case of at least the first side and the third side is along the first fastening means, and afterwards
moving the second side towards the upper side of the pallet on top of one of the first side, third side, fourth side, preferably by folding the second side along a foldable line arranged parallel to the edge of the second side facing towards the pallet in distance of at least the cumulative thickness of first side, third side and fourth side.

The required time to collapse the container is about a few minutes or less. If the container further comprises a cover, e.g. to secure the loaded objects or to strengthen the sidewall in order to achieve a stackable container (if the stiffness of the sidewall itself is not sufficient to provide a stackable loaded container), the cover may be placed on top of the second side. The cover alternatively may be placed separate from the collapsed container. In a preferred exemplary embodiment, folding is used as fast procedure to collapse the second side which reduces the required collapsing time.

In another exemplary embodiment, where the fourth side is a door, preferably a double wing door, the method further comprises the steps
moving the door connected with the first side and/or third side towards the first side and/or third side, afterwards
moving the first side or third side towards the upper side of the pallet, and
moving the third side or first side towards the upper side of the pallet.

The subject innovation further relates to a closable sidewall comprising a first side, a second side, a third side and a fourth side and second fastening means suitable to be used in a container.

The subject innovation further relates to a pallet with a loadable upper side and first fastening means arranged apart from the edges of the pallet suitable to be used in a container.

### BRIEF DESCRIPTION OF THE DRAWINGS

The above discussed embodiments are only examples. Skilled people may consider modifications of said embodiments within the scope of the subject innovation. More details of the subject innovation are shown in the following figures and the detailed description of exemplary embodiments.

FIG. 1 is a perspective view of a container according to the subject innovation and its fourth side;

FIG. 2 is a diagram showing a series of side views of second side (a), first side (b) and third side (c) with a double wing door as the fourth side, and a top view of the pallet (d);

FIG. 3 is a front view of a loaded container with opened double wing door with opening angle 180°;

FIG. 4 is a diagram of a side view of a forklift stacking two containers according to the subject innovation;

FIG. 5 is a perspective view of a container according to the subject innovation with cover on top of the sidewall;

FIG. 6 is a side view of a loaded volume in a Nordic pool size trailer (dotted line for prior art container, dashed line for container according the subject innovation); and

FIG. 7 is a side view of a partly collapsed container and stacked fully collapsed containers.

### DETAILED DESCRIPTION OF SPECIFIC EMBODIMENTS

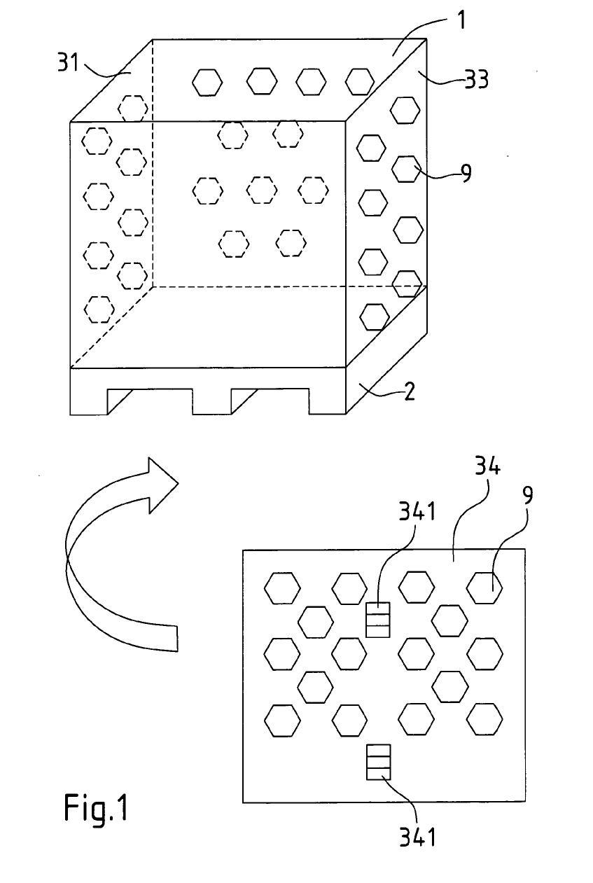

FIG. 1 shows a container 1 according to the subject innovation in a perspective view. The pallet 2 is shown as a black bottom. The sidewall 31, 32, 33, 34 is placed onto the pallet 2. For a better view, the details of the fourth side 34 are shown separately below the container. The arrow indicates, that the fourth side 34 is located on the pallet between first side 31 and third side 33 as part of the sidewall. The sidewall 31, 32, 33, 34 of FIG. 1 comprises openings 9 to lower the weight of the sidewall. The hexagonal shape of the openings is only one possible example and may have any other shape in other embodiments. In alternative embodiments, the sidewall may have no openings in order to improve the stiffness (strength) of the container in order to be stackable. However, also containers with openings 9 can be stacked, if the stiffness of the sidewall is sufficient, for example depending on the thickness of the sidewall, its material and the size and weight of the container to be stacked. The first and second fastening means and the closing means of the sidewall are not shown is this figure.

The fourth side 34 in FIG. 1 can be attached and detached from the first side 31 and second side 33 in order to open the container 1 to load the container with objects. If detached, the fourth side 34 may be taken away from the pallet 2 using the fourth side holders 341. The position and shape of the holders 341 is only an example. People skilled in the art may consider other means, arrangements and shapes to remove the fourth side 34 from the remaining sidewall 31, 32, 33 and pallet 2.

The size of pallet 2 and sidewall 31, 32, 33, 34 can be customized and may have any desired length, depth and height. However, containers (pallet+sidewall) adapted to available storage spaces in trucks, trailers, trains, ships and air planes are advantageous, because the effective use of the available space to transport objects decreases the transportation costs and time.

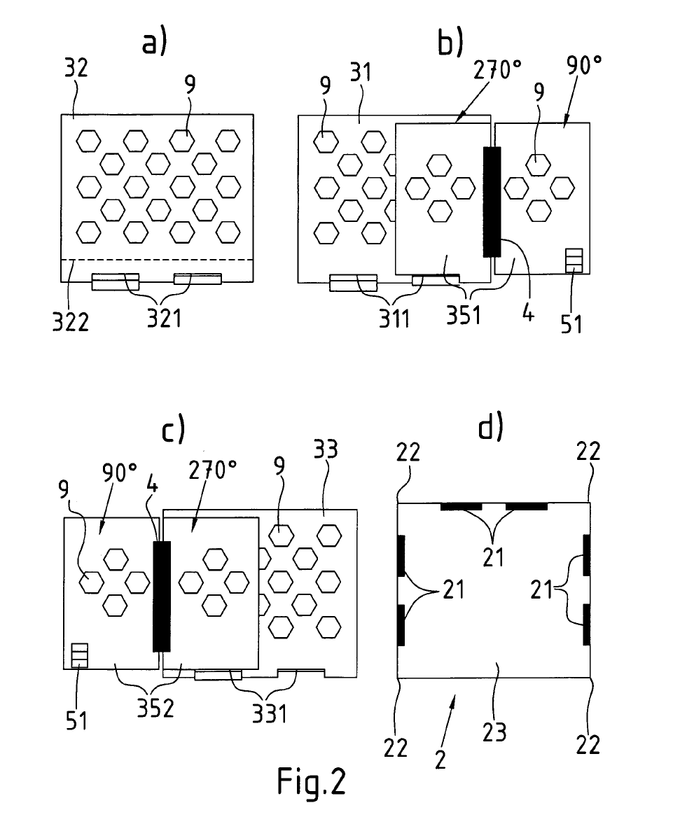

The container 1 comprises a pallet 2, a sidewall with a first side 31, a second side 32, a third side 33 and a fourth side 34, which can be a door or a double wing door 351, 352 as shown in FIG. 2. FIG. 2 shows the parts of the container 1 as side views for (a) the second side 32, (b) the first side 31, (c) the third side 33 and (d) a top view of the pallet 2. Here, the fourth side 34 is a double wing door, where a first wing of the door 351 is attached to the first side 31 via opening means 4 to hold and open the first wing 351. Correspondingly, a second wing 352 of the double wing door is attached to the third side 33 via opening means 4 to hold and open the door. The opening means can be identical for both first and second wings 351 and 352 or may be different depending on the desired opening characteristics. People skilled in the art will select the appropriate opening means for the desired opening characteristics. As an example, the wings 351 and 352 are shown in FIG. 2 in two different positions, with an opening angle of 90° and another opening angle of 270°. The minimum opening angle required to be able to load the complete loadable volume directly is 90°. The maximum opening angle is 270°, when the door wing(s) contact the outside surface of the first and/or the third side. The opening means may provide any maximum opening angle between 90° and 270°. In an alternative embodiment with a single wing door as the fourth side 34, the previously discussed features and limitations are valid also. The opening means 4 may enable the door wings turned to the inside surface of the first and/or third side. The opening angle of 90° to the inside of the container should not be used for loading the container, because the door wings cannot be closed after loading, but this opening angle might be important to collapsed the sidewall of the container, where the door wings are still fixed to the first and/or third side via the opening means 4. The first and second wings 351 and 352 of the double wing door as the fourth side 34 comprise closing means 51. The closing means 51 will further secure the loaded objects within the container from getting lost during transport, because a locked door cannot be opened accidentally. People skilled in the art will chose appropriate closing means in order to lock the door safety. In alternative embodiments there are 2, 3 4 or more closing means on each door or door wing.

The connection means to connect the parts of the sidewall, the first side 31, the second side 32, the third side 33, the fourth side 34 or the door 351 and 352, together in order to build a closed sidewall enclosing the loaded objects of the container are not shown in details in FIG. 2. People skilled in the art will chose any appropriate connection means to connect said parts. Examples of appropriate connection means are clips, flaps, pins, bolts anchors, clamps, clips, mounting links and hooks. The number and position of the connecting means on the parts of the sidewall may be chosen by skilled people depending on size, maximum load, material etc. of sidewalls and pallets.

The square pallet 2 comprises edges 22. The square shape of the pallet 2 is only one example of any possible shapes. However, a square shape with adapted sizes may be advantageous for certain available storage spaces in transporting vehicles such as trucks, trailers, trains, ships, air planes etc. The pallet 2 comprises first fastening means 21 arranged at three sides of the pallet in order to fit into the corresponding second fastening means 311, 321, 331 of the first side 31, second side 32 and third side 33 in order to fasten the sidewall 31, 32, 33, 351 and 352 (=34) on the pallet 2. The pallet shown in FIG. 2 has no first fastening means at the fourth side, because the fourth side is arranged as a double wing door in this example. Fastening means at the fourth side would hamper opening of the door. Additional, fastening means at the fourth side in case of the fourth side as a door are not required, because the door 351 and 352 is fastened to the pallet 2 via the opening means 4 fastening the door 351,352 to the first and third side 31, 33 and via the fastening means 311 and 331 of left and right side 31 and 33 to the pallet 2. In this example the first fastening means 21 are rectangular protrusions such as ledges, edges, lugs etc. The sidewall has corresponding recesses or notches as second fastening means 311, 321, 331 fitting onto the first fastening means. During collapsing the container, the first side 31 and the third side 33 can be turned towards the upper side 23 of the pallet 2 by turning these sides around the first fastening means 21 onto the pallet 2. After collapsing the first and third sides 31 and 33, the fastening means 21, 311, 331 are still in fitting contact, if protrusion and recess are of appropriate height. The collapsing procedure may be further supported by additional bolts, pins etc. improving the fastening of first and second fastening means while simultaneously maintain the rotatability of the first and third side along the first fastening means. Examples of appropriate first and second fastening means are hinges, clips, flaps, pins, bolts, clamps, clips, mounting links, angle, hooks, local ledges, local edges or combinations thereof. People skilled in the art might chose alternative fastening means within the scope of the subject innovation.

The openings 9 shown in FIG. 2 are only one possible example to design the sidewall. Sidewalls according to the subject innovation may have different numbers of openings, openings with different shape or no openings.

The second side 32 further comprises a foldable line 322 in order to move the second side 32 towards the upper side of the pallet 23 as the last step of the collapsing procedure for the container. A second side with such foldable line 322 can be kept fastened to the pallet also in the collapsed status of the container.

Therefore second sides 32 with foldable lines 322 may have different second fastening means 321 to fit into the first fastening means 21 of the pallet at the side corresponding to the second site of the sidewall. In alternative embodiments the first fastening means 21 of the pallet at the this side could be different to the first fastening means at the sides of the pallet corresponding to the first and third sides of the sidewall.

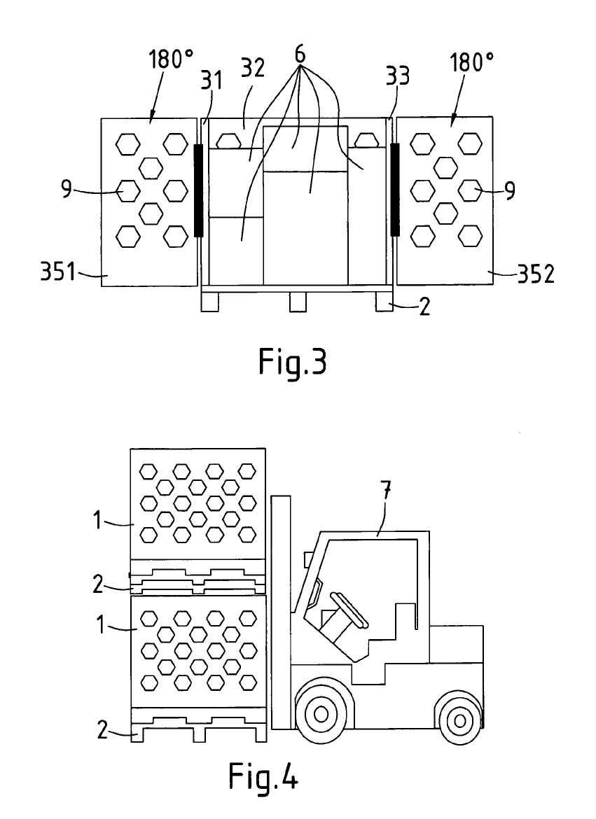

FIG. 3 shows a container 1 with openings 9 in the sidewall 31, 32, 33, 351, 352 loaded with objects 6 from a front view with opened fourth side as an opened double wing door 351, 352, where the opening angle of the door wings is 180°. An opening angle larger than 90° improves the possibility to load the container from larger angles. The sidewall secures the loaded objects against slipping during transport and provides protection against side impacts. The closed sidewall will prevent the loss of objects in comparison to lose load pallets.

FIG. 4 shows two stacked containers 1, where the second container is stacked on top of the first container with a forklift 7. The pallet 2 as part of the container 1 enables handling of the containers by forklifts 7, which saves time and therefore costs in case of large and/or heavy weight containers. The stiffness of the sidewall has to be sufficient to stack at least another container on top of the first container. Pallet and loadable volume define a maximum load weight. The stiffness of the sidewall has to be adapted to this maximum load weight in order to be stackable. Thickness of the sidewall and material of the sidewall are two examples of parameters determine the stiffness of the sidewall within the scope of the subject innovation, if necessary.

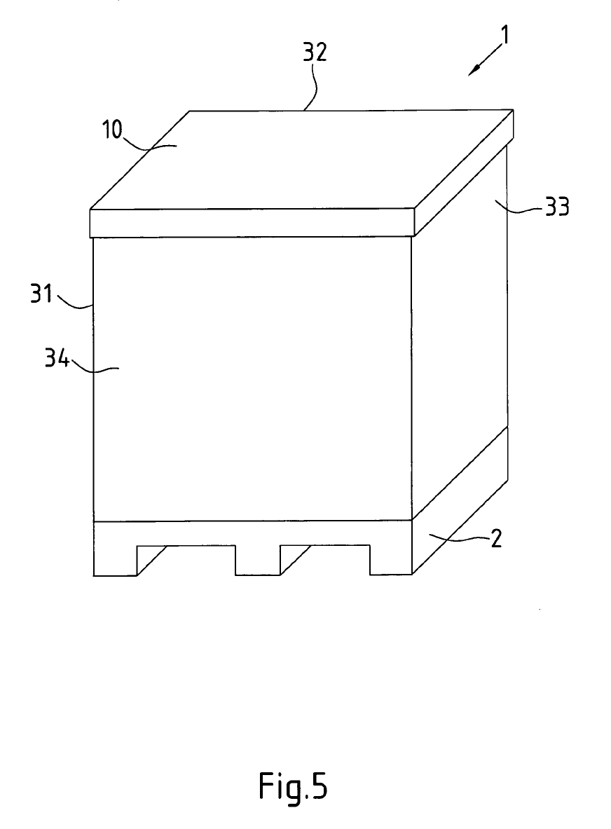

One further example to improve the stiffness of the container is shown in FIG. 5. Here the container 1 comprises an additional cover 10 placed on top of the sidewall 31, 32, 33, 34. In this example, the container comprises no openings 9 in order to further improve the stiffness of the sidewall. The cover is shaped to conform with the loadable volume defined by the sidewall and may comprise a cover top and covers sides, the cover being adapted to be removable and to locate on an outer surface of the sidewall in the manner of a snug fit. The removability of the cover is required in order to maintain the possibility to collapse the container in case of no loaded object in order to save back-transportation space. If the cover is not removed during the loading process, the lay-out of the cover must not affect the opening mechanism of the fourth side, especially in case of doors or double wing doors. For example, suitable covers might have no cover side at the fourth side of the container, or a smaller cover side not blocking the opening of the door.

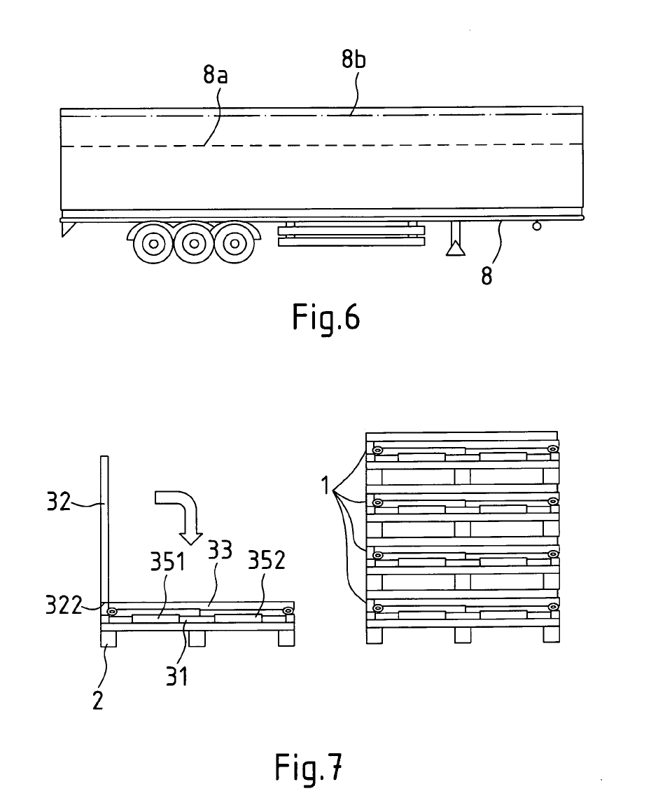

As an example for the improved loading capability FIG. 6 shows a comparison of the used storage space (load capacity) of a Nordic pool size trailer 8 for stackable container according to the subject innovation (dashed line 8b) and pallets with standard metal cages (dotted line 8a). As clearly shown, a much better use of the available space of this trailer is achieved with the stacked containers (one container on top of a first container) with pallet sizes of 120×120 cm² and total container heights of 120 cm. A stack of two of this containers (120×120×120 cm³) arranged in two lines in the trailer 8 lead to a nearly 100% use of the available storage space in the Nordic pool size trailer 8. This is a 25% more effective use compared to trailers loaded with standard pallets 80×120 cm² with metal cages with a total height of 190 cm. As a result of the larger pallet size, the loading time of the trailer is reduced, because the number of pallets transported within the trailer is lower in case of larger pallet sizes, which correspondingly results in a lower number of required loading actions (e.g. forklift transports).

To collapse the container, the connection means of the sidewall have to be opened. In one embodiment, all connection means are opened first before starting to collapse the container. In an alternative embodiment, only the connection means of the part of the sidewall to be collapsed are opened. Then the part of the sidewall will be collapsed and the next connection means of the next part of the sidewall are opened in order to be able to collapse the next part of the sidewall and so on. The FIG. 7 shows a partly collapsed container 1 (left side) and a stack of 4 fully collapsed containers 1 (right side). As one possible example of collapsing procedures, the first side 31 connected to the first wing 351 of the double wing door is placed on top of the upper side of the pallet 2 with the first wing 351 turned to 270° to the outer side of the first side 31 (first side and door are into contact). To fit to the first side with door, the third side 33 and the second wing 352 of the double wing door are detached from the pallet and are turned around and the second wing is turned to 90° to the inner side of the third side 31 (third side and door are into contact). Here the term “inner side” denotes the surface of the sidewall, which is the inner side of the container. Correspondingly, the term “outer side” denotes the surface of the sidewall, which is the outer side of the container. The sequence may be altered and the above described procedure can to be executed in an inverted manner resulting in an equivalent status of the partly collapsed container. As the last step of collapsing the container, the second side may be folded along the foldable line 322 towards the previously collapsed first and third sides 31, 33 with attached door 351, 352. In this embodiment, the second fastening means 321 of the second side 32 are kept fastened to the first fastening means 21 of the pallet 2 of its side corresponding to the second side of the sidewall. Alternatively, a second side 32 without a foldable line 322 might be detached from the pallet 2 and placed on top of the previously collapsed first and second sides with attached door. In case of a fourth side 34 not arranged as a door 351, 352, the fourth side 34 may replace the layer of first and second door wings 351 and 352 as shown in FIG. 7. Alternatively, the fourth side 34 may be placed on top of the collapsed first and third sides. However, all previously disclosed collapsing methods lead to a dense package of the collapsed sidewall. This is advantageous in case of stacked transport of collapsed containers, because the weight of collapsed containers will not damage the collapsed containers below, if the collapsed sidewalls are in a dense package at least similar to the package shown in FIG. 7.

The shown embodiments must not be considered as limitation of the subject innovation. The discussed embodiments are only examples of the subject innovation. People skilled in the art may consider alternative embodiments of the subject innovation as set forth herein still falling into the scope of the subject innovation, as set forth in the claims.

### LIST OF REFERENCES

1 container according to the subject innovation
2 pallet
21 first fastening means
22 edges of the pallet
23 upper side of the pallet
31 first side of the sidewall
32 second side of the sidewall
33 third side of the sidewall
34 fourth side of the sidewall
311 second fastening means of the left side
321 second fastening means of the backside
322 foldable line
331 second fastening means of the right side
341 front side holders
351 first wing of a double wing door as part of the front side
352 second wing of a double wing door as part of the front side
4 opening means
51 closing means
6 object (loaded, to be loaded)
7 forklift
8 Nordic pool size trailer
8a used storage space in case of metal cage pallets
8b used storage space in case of container according to the subject innovation
9 opening (within the sidewall)
10 cover (for the sidewall)

1-15. (canceled)

16. A container loadable with at least one object, the container comprising:
a pallet with a loadable upper side and first protruding fastening means arranged apart from the edges of the pallet;
a closable sidewall with second fastening means suitable to fit into the first fastening means of the pallet comprising at least a first side, a second side, a third side and a fourth side, where the fourth side is configured to be opened to load the container;
the sidewall and the pallet being fastened together with the first and second fastening means defining a loadable volume which is able to be collapsed in case of no loaded objects by moving the sidewall towards the upper side of the pallet, for of at least two of the first to fourth sides along the first fastening means; and
the sidewall being detachable from the pallet and the sides of the sidewalls being detachable from each other to enable a separate replacement of the sides without replacing the complete sidewall.

17. The container recited in claim 16, wherein at least the first side, the second side and the third side are connected to each other via connection means comprising clips, flaps, pins, bolts anchors, clamps, clips, mounting links and hooks to achieve a closed sidewall.

18. The container recited in claim 16, wherein the fourth side is provided as a double wing door connected to the vertical edge of the first side and/or third side facing towards the fourth side via at least one opening means that provides an opening angle of the door of 90°, 180°, or 270°, the double wing door comprising one or more closing means on each door wing to lock the double wing door.

19. The container recited in claim 18, the opening means comprising at least one element selected from the group of a flexible joint, an angle, a clip, or a flap.

20. The container recited in claim 16, wherein the pallet and the sidewall define a customized loadable volume of 120×120×120 cm³.

21. The container recited in claim 16, comprising supporting posts located in the corners of the pallet or a cover for the sidewall to further improve the stiffness of the sidewall.

22. The container recited in claim 16, wherein the sidewall consists essentially of at least one of a material selected from the group of materials comprising cardboard and treated cardboard, the cardboard or treated cardboard being water resistant and/or recyclable.

23. The container recited in claim 16, wherein at least one of the first side, second side, third side and fourth side comprises at least one opening in order to reduce the weight of the sidewall.

24. The container recited in claim 16, wherein the first and second fastening means comprise at least one element selected from the group consisting of clips, flaps, pins, bolts, clamps, clips, hooks, local ledges, local edges, or combinations thereof.

25. The container recited in claim 16, wherein the second side of the sidewall comprises a foldable line arranged parallel to the edge of the second side facing towards the pallet in a distance of at least the cumulative thickness of first side, third side and fourth side for folding the second side on top of the collapsed first side, third side and fourth side.

26. A method of collapsing a container loadable with at least one object, the container comprising a pallet with a loadable upper side and first protruding fastening means arranged apart from the edges of the pallet, the container also comprising a closable sidewall with second fastening means suitable to fit into the first fastening means of the pallet comprising at least a first side, a second side, a third side and a fourth side, where the fourth side is configured to be opened to load the container, the sidewall and the pallet being fastened together with the first and second fastening means defining a loadable volume which is able to be collapsed in case of no loaded objects by moving the sidewall towards the upper side of the pallet, for of at least two of the first to fourth sides along the first fastening means, the sidewall being detachable from the pallet and the sides of the sidewalls being detachable from each other to enable a separate replacement of the sides without replacing the complete sidewall, the method comprising:
opening the connection means of the sidewall;
moving the first side, the third side and the fourth side towards the upper side of the pallet, wherein the movement is in case of at least the first side and the third side along the first protruding fastening means;
afterwards, moving the second side towards the upper side of the pallet on top of one of the first side, third side and fourth side; and
replacing a damaged side separately without replacing the complete sidewall by detaching the first side, the second side, the third side and the fourth side from each other and from the pallet.

27. The method recited in claim 26, wherein moving the second side is executed by folding the second side along a foldable line arranged parallel to the edge of the second side facing towards the pallet in distance of at least the cumulative thickness of first side, third side and fourth side.

28. The method recited in claim 26, wherein the fourth side is provided as a double wing door connected to the vertical edge of the first side and/or third side facing towards the fourth side via at least one opening means that provides an opening angle of the door of 90°, 180°, or 270°, the double wing door comprising one or more closing means on each door wing to lock the double wing door, the method comprising:
moving the door wings connected with the first side and the third side towards the first side and towards the third side;
afterwards, moving the first side or third side towards the upper side of the pallet; and
moving the third side or first side towards the upper side of the pallet.

29. A closable sidewall comprising a first side, a second side, a third side and a fourth side and second fastening means made of at least one a material selected from the group of materials comprising cardboard and treated cardboard for use in a container loadable with at least one object, the container comprising a pallet with a loadable upper side and first protruding fastening means arranged apart from the edges of the pallet, the container also comprising a closable sidewall with second fastening means suitable to fit into the first fastening means of the pallet comprising at least a first side, a second side, a third side and a fourth side, where the fourth side is configured to be opened to load the container, the sidewall and the pallet being fastened together with the first and second fastening means defining a loadable volume which is able to be collapsed in case of no loaded objects by moving the sidewall towards the upper side of the pallet, for of at least two of the first to fourth sides along the first fastening means, the sidewall being detachable from the pallet and the sides of the sidewalls being detachable from each other to enable a separate replacement of the sides without replacing the complete sidewall, the second side of the sidewall comprising a foldable line arranged parallel to the edge of the second side facing towards the pallet in a distance of at least the cumulative thickness of first side, third side and fourth side for folding the second side on top of the collapsed first side, third side and fourth side.

30. A pallet with a loadable upper side and first protruding fastening means arranged apart from the edges of the pallet for use in a container loadable with at least one object, the container comprising a pallet with a loadable upper side and first protruding fastening means arranged apart from the edges of the pallet, the container also comprising a closable sidewall with second fastening means suitable to fit into the first fastening means of the pallet comprising at least a first side, a second side, a third side and a fourth side, where the fourth side is configured to be opened to load the container, the sidewall and the pallet being fastened together with the first and second fastening means defining a loadable volume which is able to be collapsed in case of no loaded objects by moving the sidewall towards the upper side of the pallet, for of at least two of the first to fourth sides along the first fastening means, the sidewall being detachable from the pallet and the sides of the sidewalls being detachable from each other to enable a separate replacement of the sides without replacing the complete sidewall, wherein the first fastening means comprise at least one element of the group of clips, flaps, pins, bolts, clamps, clips, hooks, local ledges or local edges, or combinations thereof.
